(19) United States
(12) Patent Application Publication
(10) Pub. No.: US 2025/0243830 A1
(43) Pub. Date: Jul. 31, 2025

(54) EGR VALVE CONTROL APPARATUS

(71) Applicant: Honda Motor Co., Ltd., Tokyo (JP)

(72) Inventors: Yosuke Yamada, Tokyo (JP); Hiroshi Kubo, Tokyo (JP); Yusuke Nishiguchi, Tokyo (JP); Hiroyuki Aio, Tokyo (JP)

(21) Appl. No.: 19/032,084

(22) Filed: Jan. 19, 2025

(30) Foreign Application Priority Data
Jan. 25, 2024 (JP) 2024-009161

(51) Int. Cl. F02M 26/50; F02M 26/40

(52) U.S. Cl. CPC F02M 26/50; F02M 26/40

(57) ABSTRACT

An EGR valve control apparatus includes: an EGR valve configured to adjust an exhaust gas recirculation amount of an internal combustion engine mounted on a vehicle, a detector configured to detect a caught state in which foreign matter is caught in the EGR valve, and a controller configured to control the EGR valve. The controller controls the EGR valve to perform an opening and closing operation, in which the EGR valve opens and closes a predetermined number of times, on condition that the caught state is detected by the detector when rotation of the internal combustion engine is stopped in a state where an ignition switch of the vehicle is on.

### CROSS-REFERENCE TO RELATED APPLICATION

This application is based upon and claims the benefit of priority from Japanese Patent Application No. 2024-009161 filed on Jan. 25, 2024, the content of which is incorporated herein by reference.

### BACKGROUND OF THE INVENTION

### Field of the Invention

The present invention relates to an EGR valve control apparatus that controls an EGR (Exhaust Gas Recirculation) valve of an internal combustion engine mounted on a vehicle.

### Description of the Related Art

In recent years, in a vehicle having an EGR valve, research and development have been conducted for the purpose of contributing to the development of a sustainable transportation system by ensuring the soundness of the EGR valve and improving the safety of the vehicle and traffic. As a technique related to this type of EGR valve, a device that removes foreign matter adhering to the EGR valve when the internal combustion engine is stopped is conventionally known. For example, in the device described in JP H08-303307 A, when the ignition switch is turned off and the operation of the internal combustion engine is stopped, the EGR valve is closed and then fully opened. In the device described in JP 2007-064166 A, in a case where the operation of the internal combustion engine is started after the ignition ON operation is performed and then the ignition OFF operation is performed, the EGR valve is reciprocated to open and close near the fully closed position.

Meanwhile, at the time of idle stop of the vehicle or at the time of stall of the internal combustion engine, the internal combustion engine may stop in a state where the ignition switch is on. At this time, if foreign matter is caught in the EGR valve, the EGR valve cannot be completely closed, and the EGR gas flows into the combustion chamber at the time of restart, so that restart may be difficult.

### SUMMARY OF THE INVENTION

An aspect of the present invention is an EGR valve control apparatus, including: an EGR valve configured to adjust an exhaust gas recirculation amount of an internal combustion engine mounted on a vehicle; a detector configured to detect a caught state in which foreign matter is caught in the EGR valve; and a controller configured to control the EGR valve. The controller controls the EGR valve to perform an opening and closing operation, in which the EGR valve opens and closes a predetermined number of times, on condition that the caught state is detected by the detector when rotation of the internal combustion engine is stopped in a state where an ignition switch of the vehicle is on.

### BRIEF DESCRIPTION OF THE DRAWINGS

The objects, features, and advantages of the present invention will become clearer from the following description of embodiments in relation to the attached drawings, in which:

FIG. 1 is a diagram schematically showing an example of a structure containing an engine to which an EGR valve control apparatus according to an embodiment of the present invention is applied and peripheral components of the engine;

FIG. 2 is a diagram schematically illustrating an example of an internal configuration of an EGR valve in FIG. 1;

FIG. 3 is a time chart showing an example of operation of the EGR valve in FIG. 1 in one driving cycle from when an ignition switch of a vehicle is turned on to when the ignition switch is turned off;

FIG. 4 is a block diagram schematically illustrating an example of a substantial configuration of the EGR valve control apparatus according to the embodiment of the present invention;

FIG. 5 is a time chart illustrating an example of an opening and closing operation of the EGR valve;

FIG. 6 is a time chart illustrating another example of the opening and closing operation of the EGR valve;

FIG. 7 is a time chart illustrating an example of the opening and closing operation when a start request is made during the opening and closing operation of the EGR valve;

FIG. 8 is a time chart illustrating an example of the opening and closing operation when the ignition switch is turned off during the opening and closing operation of the EGR valve;

FIG. 9 is a flowchart illustrating an example of processing executed by an ECU in FIG. 4 in a state where the ignition switch of the vehicle is on;

FIG. 10 is a flowchart illustrating a modification of FIG. 9; and

FIG. 11 is a flowchart illustrating an example of processing executed by the ECU in FIG. 4 when a start request is made during the opening and closing operation of the EGR valve.

### DETAILED DESCRIPTION OF THE INVENTION

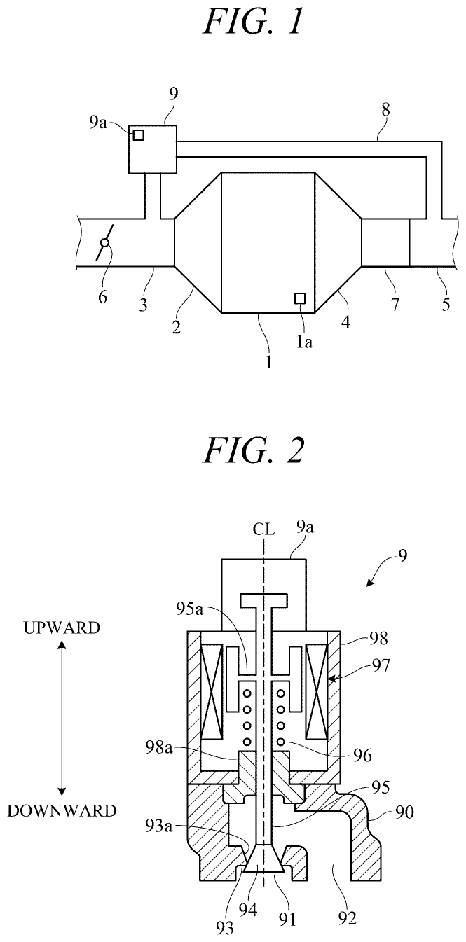

Hereinafter, embodiments of the invention will be described with reference to FIGS. 1 to 11. FIG. 1 is a diagram schematically showing an example of a structure containing an engine 1 to which the EGR valve control apparatus according to an embodiment of the present invention is applied and peripheral components of the engine 1. The engine 1 is an internal combustion engine such as a gasoline engine or a diesel engine mounted on a vehicle (not illustrated). The vehicle may be a vehicle on which only the engine 1 is mounted as a driving source, or may be a hybrid vehicle on which the engine 1 and a traveling motor are mounted. The engine 1 is provided with a rotation speed sensor 1a that detects an engine speed.

As illustrated in FIG. 1, an intake passage 3 is connected to the engine 1 via an intake manifold 2, and an exhaust passage 5 is connected to the engine 1 via an exhaust manifold 4. Air sucked into the intake passage 3 through an air cleaner (not illustrated) has a flow rate adjusted by a throttle valve 6 provided in the intake passage 3, and is supplied to the engine 1 through the intake manifold 2. The exhaust gas discharged from the engine 1 to the exhaust passage 5 via the exhaust manifold 4 is purified by the catalyst device 7 provided in the exhaust passage 5 and released into the atmosphere.

Part of the exhaust gas discharged to the exhaust passage 5 is recirculated to the intake passage 3 via the EGR passage 8. The flow rate of the exhaust gas (EGR gas) recirculated from the exhaust passage 5 to the intake passage 3 via the EGR passage 8, that is, the exhaust gas recirculation amount of the engine 1 is adjusted by the EGR valve 9 provided in the EGR passage 8. The EGR valve 9 is provided with a lift sensor 9a that detects a lift amount of a valve body (FIG. 2) corresponding to an opening degree of the EGR valve 9. The EGR valve 9 is controlled by an electronic control unit (ECU) 10 (FIG. 4) mounted on the vehicle.

FIG. 2 is a diagram schematically illustrating an example of an internal configuration of the EGR valve 9, and illustrates a state in which the EGR valve 9 is closed (fully closed). The EGR valve 9 is configured as, for example, an electric poppet valve. As illustrated in FIG. 2, the EGR valve 9 includes a valve body 90 constituting a part of the EGR passage 8. In the valve body 90, an inlet-side passage 91 connected to the EGR passage 8 on the exhaust passage 5 side and an outlet-side passage 92 connected to the EGR passage 8 on the intake passage 3 side are formed. The valve body 90 between the inlet-side passage 91 and the outlet-side passage 92 is provided with a substantially annular valve seat 93 centered on the vertical axis CL.

The EGR valve 9 further includes a valve body 94 provided to be seated on the valve seat 93, a valve shaft 95 provided integrally with the valve body 94, a compression spring 96 that biases the valve body 94 and the valve shaft 95 upward, and a solenoid 97 that drives the valve body 94 and the valve shaft 95 downward. The valve body 94 and the valve shaft 95 may be driven using a motor such as a stepping motor instead of the solenoid. The compression spring 96 and the solenoid 97 are accommodated in a housing 98 provided above the valve body 90.

The through-hole 93a of the valve seat 93 has a truncated cone surface centered on the vertical axis CL and expands in diameter upward. The valve body 94 is formed in a substantially truncated cone shape centered on the vertical axis CL and expands in diameter downward. The valve shaft 95 is provided so as to extend upward along the vertical axis CL from the upper end of the valve body 94, and is slidably supported along the vertical axis CL by a bearing 98a provided in the housing 98. The valve shaft 95 is formed with a spring bearing 95a protruding in the horizontal direction toward the outer diameter direction centered on the vertical axis CL.

The lower end of the compression spring 96 abuts on the upper end surface of the bearing 98a, the upper end of the compression spring 96 abuts on the lower end surface of the spring bearing 95a, and the compression spring 96 biases the valve body 94 and the valve shaft 95 upward via the spring bearing 95a. The solenoid 97 is connected to the spring bearing 95a and drives the valve body 94 and the valve shaft 95 downward via the spring bearing 95a.

As illustrated in FIG. 2, when the solenoid 97 is off, the valve body 94 and the valve shaft 95 are biased upward by the compression spring 96, and the truncated cone surface of the valve body 94 abuts on the lower end of the valve seat 93 (through-hole 93a), so that the valve body 94 is seated on the valve seat 93, whereby the EGR valve 9 is closed. When the solenoid 97 is turned on, the valve shaft 95 and the valve body 94 are driven downward against the biasing force of the compression spring 96, and the valve body 94 is separated from the valve seat 93, whereby the EGR valve 9 is opened.

The lift amount of the valve body 94 corresponding to the opening degree of the EGR valve 9, that is, the separation amount of the valve body 94 from the valve seat 93 is detected by the lift sensor 9a provided at the upper end portion of the valve shaft 95. The lift amount when the EGR valve 9 is fully closed is 0 mm, and the lift amount when the EGR valve 9 is fully opened is, for example, about 5 mm. The electrification amount to the solenoid 97 is controlled by the ECU 10 (FIG. 4), whereby the lift amount (0 to 5 mm) of the EGR valve 9 is adjusted, and the flow rate of the EGR gas is adjusted. The target lift amount of the EGR valve 9 is determined by predetermined characteristics according to the operating state of the engine 1 and the like, and the EGR valve 9 (solenoid 97) is feedback-controlled so that the lift amount detected by the lift sensor 9a becomes the target lift amount.

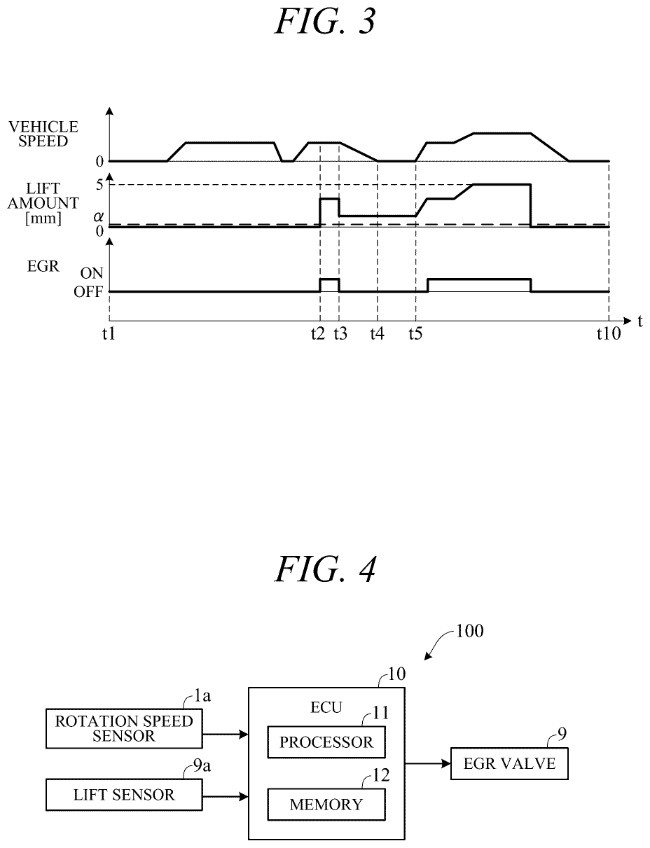

FIG. 3 is a time chart showing an example of the operation of the EGR valve 9 in one driving cycle from when the ignition switch of the vehicle is turned on to when the ignition switch is turned off, and shows the operation of the EGR valve 9 at the time of cold start. As illustrated in FIG. 3, even when the ignition switch of the vehicle is turned on at t1, the engine 1 starts to operate, and the vehicle starts to travel, the opening of the EGR valve 9 is prohibited and the valve closed state is maintained until the engine water temperature reaches a predetermined water temperature that can operate the EGR valve 9. When the predetermined water temperature is reached at t2, the opening of the EGR valve 9 is permitted, and the EGR valve 9 is feedback-controlled so as to have a target lift amount determined according to the operation state of the engine 1 or the like. Thereafter, when the vehicle is decelerated at t3 and enters a deceleration fuel cut state in which fuel supply to the engine 1 is cut off, the vehicle is stopped at t4, and the closing of the EGR valve 9 is commanded until the vehicle starts traveling again at t5.

In the example of FIG. 3, a lift amount of a predetermined value α (for example, about 0.5 to 1.0 mm) or more is detected although the closing of the EGR valve 9 is commanded at t3 to t5. This means that a caught state in which foreign matter is caught in the EGR valve 9 occurs. For example, when the valve body 94 moves upward (in the valve closing direction) in response to the valve closing command at t3, the foreign matter flowing from the inlet-side passage 91 in FIG. 2 and sandwiched between the valve seat 93 and the valve body 94 is caught between the lower end of the valve seat 93 (through-hole 93a) and the truncated cone surface of the valve body 94 at t2 to t3. Alternatively, the foreign matter flowing in from the inlet-side passage 91 and passing between the valve seat 93 and the valve body 94 is caught between the lower end of the valve seat 93 (through-hole 93a) and the truncated cone surface of the valve body 94 at t3. In this case, when the valve body 94 is seated on the valve seat 93 with the foreign matter interposed therebetween, the lift amount becomes larger than the lift amount (0 mm) in a case where the valve body abuts on the valve seat without the foreign matter interposed therebetween, and becomes greater than or equal to a predetermined value α (for example, about 0.5 to 1.0 mm).

Examples of the foreign matter caught between the valve seat 93 and the valve body 94 in this manner include foreign matter formed by peeling off deposits which are combustion products (oxides and carbides) contained in the EGR gas accumulated on the wall surface of the gas flow path such as the EGR passage 8. When the EGR gas flows through the EGR passage 8, such foreign matter passes between the valve seat 93 and the valve body 94 without being caught as long as the EGR valve 9 has an opening degree close to the full opening. When the EGR gas does not flow through the EGR passage 8, the EGR valve 9 is fully opened so that the EGR gas can fall off downward in the direction of gravity, that is, toward the inlet-side passage 91.

When the vehicle restarts traveling and the opening degree of the EGR valve 9 increases, the foreign matter caught in the EGR valve 9 passes to the outlet-side passage 92 together with the EGR gas. However, at the time of idle stop of the vehicle or stall of the engine 1, restart itself may be difficult if foreign matter is caught in the EGR valve 9. That is, since the EGR valve 9 cannot be fully closed in a state where foreign matter is caught, the EGR gas flows into the combustion chamber at the time of restart, so that an appropriate air-fuel ratio cannot be secured, and restart becomes difficult.

Therefore, in the present embodiment, the EGR valve control apparatus is configured as follows so as to remove the caught foreign matter by opening and closing the EGR valve 9 in a case where the engine 1 is stopped with the ignition switch turned on while the foreign matter is caught in the EGR valve 9.

FIG. 4 is a block diagram schematically illustrating an example of a substantial configuration of an EGR valve control apparatus (hereinafter, an apparatus) 100 according to the embodiment of the present invention. As illustrated in FIG. 4, the apparatus 100 mainly includes an ECU 10 that controls the EGR valve 9, a rotation speed sensor la, a lift sensor 9a, and the EGR valve 9 (solenoid 97) each connected to the ECU 10. Note that, although not illustrated, the ECU 10 is further connected to various sensors mounted on the vehicle, other ECUs, and the like, and receives detection values, command values, and the like of various parameters indicating the operation state of the vehicle, such as the accelerator opening degree and the engine water temperature. The ECU 10 includes a computer including a processor 11 such as a CPU, a memory 12 such as a ROM and a RAM, and other peripheral circuits. The ECU 10 is configured as, for example, an engine control ECU that controls the entire engine 1 including the throttle valve 6, an injector, and the like in addition to the EGR valve 9.

When the ignition switch of the vehicle is turned off, the ECU 10 controls the EGR valve 9 to perform opening and closing operations a predetermined number of times (for example, three times). More specifically, the target lift amount (0 mm→5 mm→0 mm→5 mm→0 mm→5 mm→0 mm) is commanded to the EGR valve 9 (solenoid 97) such that the valve body 94 of the EGR valve 9 reciprocates between the fully closed position and the fully open position a predetermined number of times. As a result, even in a case where foreign matter is caught in the EGR valve 9, the caught state can be eliminated, and the startability in the next driving cycle can be secured. Since the opening and closing operation is performed when the engine 1 is not rotating and the EGR gas is not flowing through the EGR passage 8, the EGR gas does not flow into the combustion chamber by the opening and closing operation, and does not affect the next startability.

Even in a case where the opening and closing operation is performed only once, the foreign matter can be dropped and removed before the valve body 94 reaches the fully open position. In a case where the opening and closing operation is repeated twice or more, the foreign matter can be more reliably dropped and removed by an impact when the valve body 94 is seated on the valve seat 93, vibration when the valve body is folded back from the fully opened position, and the like.

After the ignition switch of the vehicle is turned on, the ECU 10 controls the EGR valve 9 so as to perform an opening and closing operation similar to that when the ignition switch is turned off as necessary on condition that the EGR valve 9 is operated during the operation of the engine 1. That is, in a case where the EGR valve 9 is operated in the current driving cycle, the caught state may occur, but even if the engine 1 is operated during the driving cycle, the caught state does not occur when the EGR valve 9 is not operated. When the opening and closing operation of the EGR valve 9 is performed, a seating sound when the valve body 94 is seated on the valve seat 93 and an operation sound of the solenoid 97 are generated, and thus, there is a possibility that a driver feels discomfort. In addition, constant electric power is consumed by the operation of the solenoid 97. By suppressing the opening and closing operation of the EGR valve 9 to the necessary minimum, it is possible to suppress discomfort given to the driver and power consumption to the necessary minimum.

When the rotation of the engine 1 is stopped in a state where the ignition switch of the vehicle is on, the ECU 10 controls the EGR valve 9 to perform an opening and closing operation on condition that the caught state is detected by the lift sensor 9a. In an operation state in which the rotation of the engine 1 is stopped, the closing of the EGR valve 9 is always commanded, and the target lift amount (0 mm) corresponding to the fully closed position is commanded. The ECU 10 compares the lift amount of the EGR valve 9 detected by the lift sensor 9a with a predetermined value α (for example, about 0.5 to 1.0 mm) at a predetermined cycle (for example, every several seconds) at all times while the valve closing of the EGR valve 9 (target lift amount 0 mm) is commanded during the driving cycle. If the lift amount of the EGR valve 9 is greater than or equal to the predetermined value α, it is determined that the caught state has occurred, and if the lift amount of the EGR valve 9 is less than the predetermined value α, it is determined that the caught state has not occurred. The ECU 10 controls the EGR valve 9 to perform an opening and closing operation when the engine speed detected by the rotation speed sensor 1a becomes 0 rpm in a state where it is determined that the caught state has occurred.

Even during the driving cycle, the rotation of the engine 1 may stop at the time of idle stop, at the time of traveling with the traveling motor alone in the hybrid vehicle (EV traveling), at the time of stall of the engine 1, or the like. In such a case, it is highly probable that restart is required immediately after the restart. In a case where the caught state occurs when the rotation of the engine 1 is stopped during the driving cycle, the EGR valve 9 is controlled to perform the opening and closing operation, so that foreign matter can be removed and restartability can be secured. In addition, by performing the opening and closing operation of the EGR valve 9 only in a case where the caught state is detected, it is possible to suppress discomfort given to the driver and power consumption to the minimum necessary.

The opening and closing operation of the EGR valve 9 when the ignition switch is turned off may also be performed on condition that the caught state is detected. In this case, discomfort given to the driver and power consumption can be further suppressed.

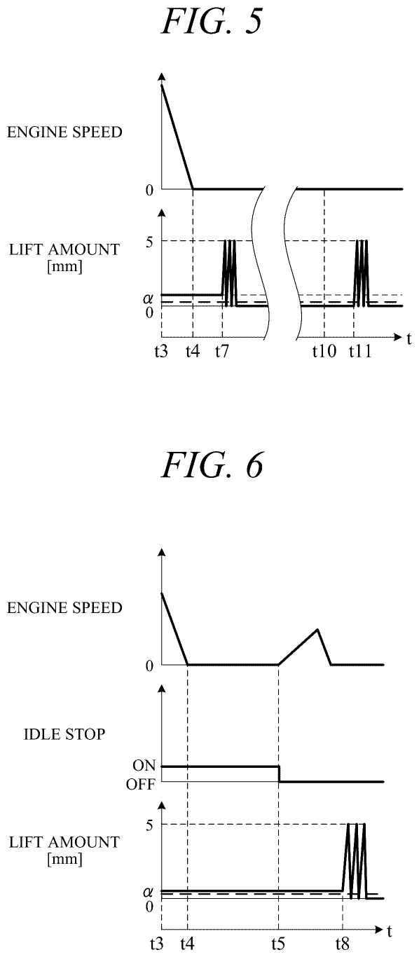

FIG. 5 is a time chart illustrating an example of an opening and closing operation of the EGR valve 9. As illustrated in FIGS. 3 and 5, it is determined that the ignition switch of the vehicle is turned on at t1, the EGR valve 9 is operated at t2 to t3, and the caught state of the EGR valve 9 occurs at t3. Thereafter, when the rotation of the engine 1 is stopped at t4 in a state where it is determined that the caught state has occurred, the opening and closing operation of the EGR valve 9 is performed at t7 to remove the caught foreign matter, and the lift amount becomes 0 mm. When the ignition switch is turned off at t10, the opening and closing operation of the EGR valve 9 is performed at t11. However, in a case where the EGR valve 9 is not operated after the opening and closing operation is performed at t7, the opening and closing operation of the EGR valve 9 is not performed at t11.

When the rotation of the engine 1 stops during the driving cycle, the ECU 10 may determine whether the caught state has occurred on condition that the engine 1 does not start against the subsequent restart request, and perform the opening and closing operation of the EGR valve 9 according to the determination result. That is, when the restart of the engine 1 according to the restart request fails after the engine speed detected by the rotation speed sensor 1a becomes 0 rpm during the driving cycle, the lift amount of the EGR valve 9 detected by the lift sensor 9a is compared with the predetermined value α. If the lift amount is greater than or equal to the predetermined value α, it is determined that the caught state has occurred, and the EGR valve 9 is controlled to perform the opening and closing operation. If the lift amount is less than the predetermined value α, it is determined that the caught state has not occurred, and the opening and closing operation is not performed.

The restart request includes a restart request instructed from the engine system side when returning from the idle stop in response to the driver's off-operation of the brake in the drive range (D range) or when shifting from the EV traveling to the traveling using the engine 1. In addition, for example, at the time of stall of the engine 1, a restart request is included which is instructed according to an ON operation of the starter through an ignition switch in a parking range (P range) by the driver.

Even if the caught state of the EGR valve 9 occurs, if the restart is successful, then when the vehicle restarts traveling and the opening degree of the EGR valve 9 increases, the foreign matter caught in the EGR valve 9 passes to the outlet-side passage 92 together with the EGR gas. By determining whether the caught state has occurred in a case where the restart has failed and performing the opening and closing operation of the EGR valve 9 according to the determination result, it is possible to further suppress the discomfort given to the driver and the power consumption.

FIG. 6 is a time chart illustrating an example of the opening and closing operation of the EGR valve 9 in a case where it is determined whether the caught state has occurred on condition that the restart fails. As illustrated in FIGS. 3 and 6, it is determined that the ignition switch is turned on at t1, the EGR valve 9 is operated at t2 to t3, and the caught state of the EGR valve 9 occurs at t3. Thereafter, when the rotation of the engine 1 is stopped at t4 and the restart of the engine 1 fails at t5 in a state where it is determined that the caught state has occurred, the opening and closing operation of the EGR valve 9 is performed at t8 to remove the caught foreign matter, and the lift amount becomes 0 mm. At t5, after the engine speed temporarily increases due to cranking in response to the restart request, the engine speed returns to 0 rpm without reaching complete explosion, and the restart fails.

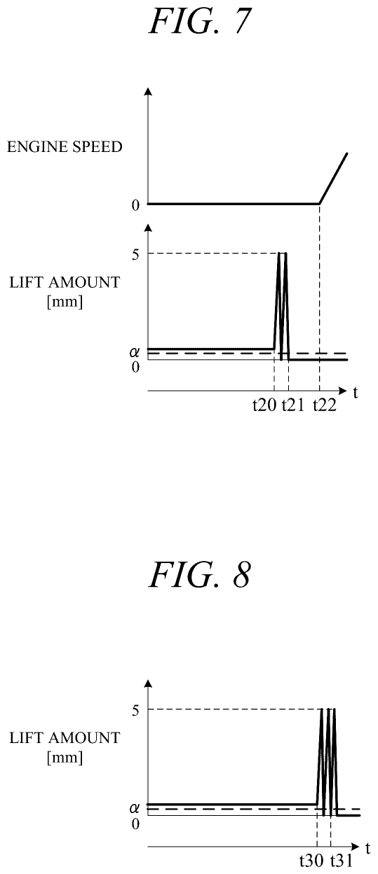

FIG. 7 is a time chart illustrating an example of the opening and closing operation when a start request is made during the opening and closing operation of the EGR valve 9. When there is a start request of the engine 1 during the opening and closing operation of the EGR valve 9, the ECU 10 controls the EGR valve 9 to stop and close the opening and closing operation. More specifically, when the valve body 94 is moving in the direction away from the valve seat 93 at the time of the start request (that is, during the valve opening operation), the valve body 94 is seated on the valve seat 93 by prohibiting the valve opening operation thereafter. If the valve body 94 is moving in the direction of seating on the valve seat 93 at the time of the start request (that is, during the valve closing operation), the valve closing operation until the valve body 94 seats on the valve seat 93 is continued, and the subsequent valve opening operation is prohibited at the time when the valve body 94 seats on the valve seat 93. The subsequent valve opening operation may be prohibited at the time when the valve body 94 is seated on the valve seat 93 after the start request. In this case, since the EGR valve 9 is fully opened at least once, foreign matter can be removed more reliably. Such a start request includes a restart request during the driving cycle and a start request of the next driving cycle immediately after the ignition switch is turned off, that is, immediately after the current driving cycle.

As illustrated in FIG. 7, when the opening and closing operation of the EGR valve 9 is started at t20, and a start request is made immediately after the second opening and closing operation is started a predetermined number of times (for example, 3 times), the opening and closing operation is ended at the time when the valve is closed at t21, and then cranking is started at t22. There is a certain delay time between the occurrence of the start request and the start of cranking. Therefore, by stopping the opening and closing operation in response to the start request, the EGR valve 9 can be reliably brought into the fully closed state at the start of cranking.

FIG. 8 is a time chart illustrating an example of the opening and closing operation when the ignition switch is turned off during the opening and closing operation of the EGR valve 9. The ECU 10 controls the EGR valve 9 to continue the opening and closing operation even when the ignition switch is turned off during the opening and closing operation. As illustrated in FIG. 8, even when the opening and closing operation of the EGR valve 9 is started at t30 and the ignition switch is turned off at t31 during a predetermined number of opening and closing operations (for example, 3 times), the predetermined number of opening and closing operations is completed. As a result, the foreign matter caught in the EGR valve 9 can be reliably removed, and the starting property in the next driving cycle can be secured.

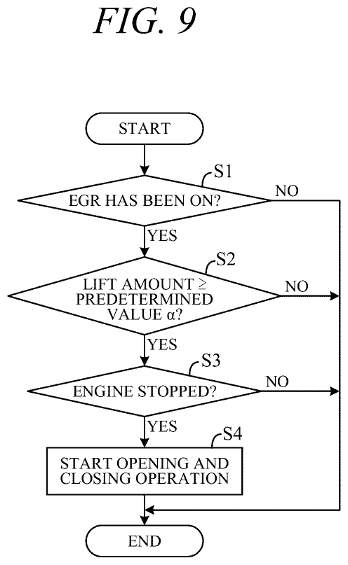

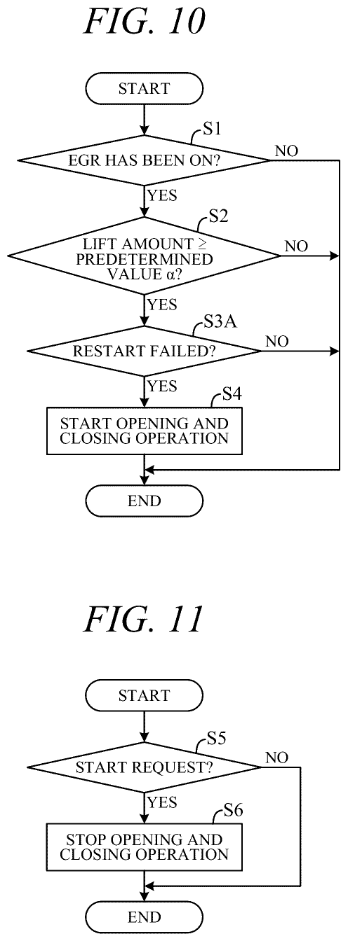

FIGS. 9 and 10 are flowcharts illustrating an example of processing executed by the ECU 10 in a state where the ignition switch of the vehicle is on. The processing illustrated in these flowcharts is started when the ECU 10 is activated, and is repeated at predetermined time intervals. As illustrated in FIG. 9, first, in S1 (S: processing step), it is determined whether there is a history that the EGR valve 9 has operated in the current driving cycle. In a case where the determination is negative in S1, the process ends, and in a case where the determination is positive, the process proceeds to S2. In S2, it is determined whether the lift amount of the EGR valve 9 detected by the lift sensor 9a at the time of the valve closing command of the EGR valve 9 is greater than or equal to a predetermined value α. In a case where the determination is negative in S2, the process ends, and in a case where the determination is positive, the process proceeds to S3. In S3, it is determined whether the engine speed detected by the rotation speed sensor 1a has changed from a state of being equal to or higher than the idle rotation speed to 0 rpm. In a case where the determination is negative in S3, the process is ended, and in a case where the determination is positive, the process proceeds to S4 to start the opening and closing operation of the EGR valve 9.

FIG. 10 is a modification of FIG. 9 and illustrates an example of processing in a case where it is determined whether a caught state has occurred on condition that restart fails. Describing a process different from that of FIG. 9, in the process of FIG. 10, when positive determination is made in S2, the process proceeds to S3A, and after the engine speed becomes 0 rpm during the driving cycle, it is determined whether the restart of the engine 1 in response to the restart request has failed. In a case where the determination is negative in S3A, the process ends, and in a case where the determination is positive, the process proceeds to S4.

FIG. 11 is a flowchart illustrating an example of processing executed by the ECU 10 when a start request is made during the opening and closing operation of the EGR valve 9. The process shown in the flowchart is repeated at predetermined time intervals during the opening and closing operation of the EGR valve 9. As illustrated in FIG. 11, it is determined whether a start request has occurred in S5, and when negative, the process is ended, and when positive, the process proceeds to S6 to stop the opening and closing operation of the EGR valve 9.

According to the embodiment of the present invention, the following effects can be achieved.

(1) The apparatus 100 includes the EGR valve 9 that adjusts an exhaust gas recirculation amount of the engine 1 mounted on the vehicle, the lift sensor 9a that detects a caught state in which foreign matter is caught in the EGR valve 9, and the ECU 10 that controls the EGR valve 9 (FIGS. 1, 2, and 4). When the rotation of the engine 1 is stopped in a state where the ignition switch of the vehicle is on, the ECU 10 controls the EGR valve 9 so as to perform the opening and closing operation a predetermined number of times on condition that the caught state is detected by the lift sensor 9a (S2 to S4 in FIGS. 5 and 9). As a result, it is possible to remove foreign matter caught in the EGR valve 9 and secure restartability when the engine rotation is stopped during the driving cycle in which it is highly likely that restart is required immediately thereafter. In addition, by performing the opening and closing operation of the EGR valve 9 only in a case where the caught state is actually detected, it is possible to suppress discomfort given to the driver and power consumption to the minimum necessary.

(2) When the rotation of the engine 1 is stopped in a state where the ignition switch is on, the ECU 10 further controls the EGR valve 9 to perform the opening and closing operation on condition that the engine 1 is not started against the start request of the engine 1 (S2A and S4 in FIGS. 6 and 10). By determining whether the caught state has occurred in a case where the restart has failed and performing the opening and closing operation of the EGR valve 9 according to the determination result, it is possible to further suppress the discomfort given to the driver and the power consumption.

(3) The ECU 10 further controls the EGR valve 9 to perform the opening and closing operation when the ignition switch is turned off (FIG. 5). As a result, even in a case where foreign matter is caught in the EGR valve 9 at the end of the current driving cycle, the caught state can be eliminated, and startability in the next driving cycle can be secured.

(4) When there is a start request of the engine 1 during the opening and closing operation, the ECU 10 controls the EGR valve 9 to stop the opening and closing operation and close the valve (FIG. 7, FIG. 11). By stopping the opening and closing operation in response to the start request, the EGR valve 9 can be reliably brought into the fully closed state at the start of cranking.

(5) The ECU 10 controls the EGR valve 9 to continue the opening and closing operation even when the ignition switch is turned off during the opening and closing operation (FIG. 8). As a result, the foreign matter caught in the EGR valve 9 is reliably removed, and the starting property in the next driving cycle can be secured.

(6) After the ignition switch is turned on, the ECU 10 controls the EGR valve 9 so as to perform the opening and closing operation on condition that the EGR valve 9 operates during the operation of the engine 1 (FIG. 9, FIG. 10). That is, in a case where the EGR valve 9 is not operated in the current driving cycle, the caught state does not occur, and the opening and closing operation of the EGR valve 9 is not performed. By suppressing the opening and closing operation of the EGR valve 9 to the necessary minimum, it is possible to suppress discomfort given to the driver and power consumption to the necessary minimum.

The above embodiments can be modified into various forms. Hereinafter, modifications will be described. In the above embodiment, the example in which the exhaust gas after passing through the catalyst device 7 is recirculated as the EGR gas has been described in FIG. 1 and the like. However, the internal combustion engine may have an EGR valve that adjusts the exhaust gas recirculation amount, and the arrangement of each unit of the internal combustion engine is not limited to the example. For example, the exhaust gas before passing through the catalyst device 7 may be recirculated as the EGR gas. The EGR passage 8 may be directly connected to the exhaust manifold 4 instead of the exhaust passage 5, may be directly connected to the intake manifold 2 instead of the intake passage 3, or may be connected to the intake manifold 2 via an appropriate chamber or the like for mixing the EGR gas and fresh air.

In the above embodiment, the example of detecting the caught state of the EGR valve 9 using the lift sensor 9a has been described in FIGS. 1, 2, 4, and the like. However, the detection unit that detects the caught state in which foreign matter is caught in the EGR valve is not limited to such a detection unit. For example, an appropriate concentration sensor may be provided in the EGR passage 8 downstream of the EGR valve 9 to detect the concentration of the gas component contained in the exhaust gas, and the inflow of the EGR gas and the caught state of the EGR valve 9 may be detected based on the detected concentration.

In the above embodiment, the specific internal configuration of the EGR valve 9 has been illustrated and described in FIG. 2 and the like, but the EGR valve is not limited to the illustrated configuration. For example, a valve other than the poppet valve such as a butterfly valve may be used. That is, even in a butterfly valve or the like, foreign matter may be caught similarly to the poppet valve, and similar foreign matter removal can be performed by fully opening the valve. In a case where the butterfly valve is used, the valve opening degree can be detected by an angle sensor instead of the lift sensor.

In the above embodiment, the lift amount (5 mm) when the valve is fully opened, the predetermined value α (0.5 to 1.0 mm) for detecting and determining the caught state, and the like have been described by way of examples in FIGS. 3 and 5 to 8 and the like, but these are merely examples for description, and the specifications of the EGR valve are not limited to those illustrated.

The above embodiment can be combined as desired with one or more of the aforesaid modifications. The modifications can also be combined with one another.

According to the present invention, it becomes possible to secure restartability when the internal combustion engine is stopped in a state where the ignition switch is on.

Above, while the present invention has been described with reference to the preferred embodiments thereof, it will be understood, by those skilled in the art, that various changes and modifications may be made thereto without departing from the scope of the appended claims.

1. An EGR valve control apparatus, comprising:
an EGR valve configured to adjust an exhaust gas recirculation amount of an internal combustion engine mounted on a vehicle;
a detector configured to detect a caught state in which foreign matter is caught in the EGR valve; and
a controller configured to control the EGR valve, wherein
the controller controls the EGR valve to perform an opening and closing operation, in which the EGR valve opens and closes a predetermined number of times, on condition that the caught state is detected by the detector when rotation of the internal combustion engine is stopped in a state where an ignition switch of the vehicle is on.

2. The EGR valve control apparatus according to claim 1, wherein
the controller further controls the EGR valve to perform the opening and closing operation on condition that the internal combustion engine is not started against a start request of the internal combustion engine when the rotation of the internal combustion engine is stopped in the state where the ignition switch is on.

3. The EGR valve control apparatus according to claim 1, wherein
the controller further controls the EGR valve to perform the opening and closing operation when the ignition switch is turned off.

4. The EGR valve control apparatus according to claim 1, wherein
the controller further controls the EGR valve to stop the opening and closing operation and close the EGR valve when there is a start request of the internal combustion engine during the opening and closing operation.

5. The EGR valve control apparatus according to claim 1, wherein
the controller further controls the EGR valve to continue the opening and closing operation even when the ignition switch is turned off during the opening and closing operation.

6. The EGR valve control apparatus according to claim 1, wherein
the controller further controls the EGR valve to perform the opening and closing operation on condition that the EGR valve operates during operation of the internal combustion engine after the ignition switch is turned on.

7. The EGR valve control apparatus according to claim 1, wherein
the detector includes a sensor configured to detect an opening degree of the EGR valve.

8. The EGR valve control apparatus according to claim 7, wherein
the detector detects the caught state when the opening degree detected by the sensor is equal to or greater than a predetermined value when closing of the EGR valve is commanded.
